(19) United States
(12) Patent Application Publication
(10) Pub. No.: US 2021/0150548 A1
(43) Pub. Date: May 20, 2021

(54) SYSTEM FOR AUTOMATIC SEGMENTATION AND RANKING OF LEADS AND REFERRALS

(71) Applicant: salesforce.com, inc., San Francisco, CA (US)

(72) Inventors: RAJDEEP DUA, Telangana (IN); Sunil DIXIT, San Francisco, CA (US); Mani Kandar MADDURI, Hyderabad (IN); Mohan KRISHNA, Telangana (IN); Ashish TARA, Hyderabad (IN)

(21) Appl. No.: 16/901,839

(22) Filed: Jun. 15, 2020

Related U.S. Application Data
(60) Provisional application No. 62/936,966, filed on Nov. 18, 2019.

(51) Int. Cl. G06Q 30/02; G06K 9/62; G06N 20/00

(52) U.S. Cl. CPC G06Q 30/0201; G06Q 30/0204; G06K 9/6261; G06N 20/00; G06K 9/6262; G06K 9/6202; G06K 9/623

(57) ABSTRACT

Various embodiments for providing a system for the automatic segmentation and ranking of leads and referrals are described herein. An embodiment operates by receiving historical data including information about prospective customers who purchased one or more products. A set of segments of the prospective customers are identified, the historical data is grouped into the set of segments, and a predictive model for a conversion is generated for each segment based on the grouped historical data. A processor generates two or more predictive scores a new prospective customer, wherein each predictive score is based on the generated predictive model for two or more of the segments to which the new prospective customer belongs. The predictive score for the at least one new prospective customer is ranked along with predictive scores of a plurality of other prospective customers for display for at least one of the two or more segments.

### CROSS-REFERENCE TO RELATED APPLICATION

This application claims the benefit of U.S. Provisional Patent Application No 62/936,966, titled “System for Automatic Segmentation And Ranking of Leads and Referrals” to Due et al., filed on Nov. 18, 2019, which is herein incorporated by reference in its entirety.

### BACKGROUND

Salespersons have limited time and resources to which to dedicate to identifying leads and trying to close sales. New salespersons often struggle in trying to identify which potential customers are good prospects to convert into paying customers, and experienced salespersons often waste time and resources and produce inconsistent results when trying to perform a similar analysis. A salesperson wastes time, money, and computing resources in trying to identify and close sales with potential customers who are not ready to buy.

### BRIEF DESCRIPTION OF THE DRAWINGS

The accompanying drawings are incorporated herein and form a part of the specification.

FIG. 1 is a block diagram illustrating example functionality for providing a system for the automatic segmentation and ranking of leads and referrals, according to some embodiments.

FIG. 2 is an example interface of the system described herein, according to an embodiment.

FIG. 3 illustrates an example flowchart for providing a system for the automatic segmentation and ranking of leads and referrals in an example healthcare embodiment.

FIG. 4 describes referral scoring, according to an embodiment.

FIGS. 5A and 5B describes various variables and attributes that may be assigned scores for ranking leads and referrals, according to some example embodiments.

FIG. 6 is example computer system useful for implementing various embodiments.

FIG. 7 is a flowchart illustrating example operations for providing a system for the automatic segmentation and ranking of leads and referrals, according to some embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for providing a system for automatic segmentation and ranking of leads and referrals.

Salespersons have limited time and resources to which to dedicate to identifying leads and trying to close sales. New salespersons often struggle in trying to identify which potential customers are good prospects to convert into paying customers, and experienced salespersons often waste time and resources and produce inconsistent results when trying to perform a similar analysis. A salesperson wastes time, money, and computing resources in trying to identify and close sales with potential customers who are not ready to buy.

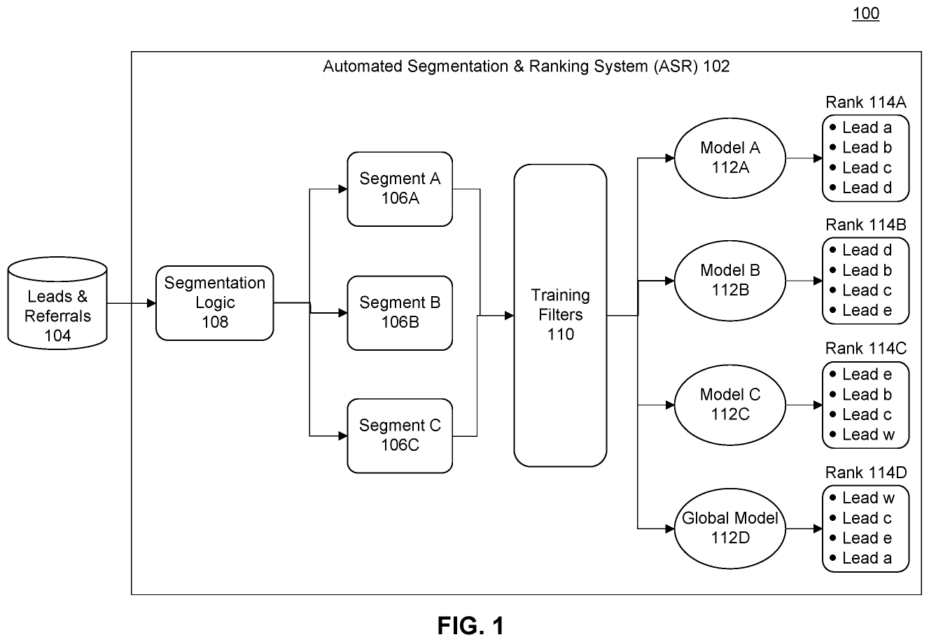

FIG. 1 is a block diagram 100 illustrating example functionality for providing a system for the automatic segmentation and ranking of leads and referrals, according to some embodiments. The automated segmentation and ranking system (ASR) 102 may receive and process leads and referrals 102.

Segmentation is the process of subdividing customers, potential customers, or groups of people into smaller groups that share similar qualities or attributes. Segmentation may be used in both application development or product development and marketing. For example, technology specific ads can be directed to smaller, more targeted customer or potential customer groups that have been divided or grouped into different segments of people with similar attributes or characteristics.

These shared similarities or attributes between customer segments may include, but not are limited to, shared behaviors (including search or browsing habits or expressed interests), hobbies, geographical location, age, education, lifestyles, income, etc. In an embodiment, segmentation may be used by salespersons to determine how to best pitch or sell certain products or services, and which customers to which to direct ads or other sales resources.

In an embodiment, there could be varied or different levels of segmentation, including for example, both high level and lower level segmentation. High level segmentation may include a broader or more general way to classify or group individuals relative to low level segmentation. For example, a high level segment may be people who ski at least twice a year, while a lower level segment may include black diamond skiers. Black diamond skiers could then be further segmented into men and women.

Once different customer segments are identified, a company can use direct marketing, sales, and/or product development activities and resources towards best serving the individual or combinations of segments, minimizing the use of computing, time, and money resources in converting sales. By automatically segmenting customers, a company may be able to identify the opportunities where the company should be investing the most effort and resources into future marketing, sales, and customer retention initiatives.

One framework for analyzing segments is known as RFM: recency, frequency, and monetary. Recency may refer to when or how recent was the segment's last engagement or purchase with a company. Frequency may refer to how frequently the segment buys or engages with a company. Monetary may refer to the average dollar purchase or lifetime value of a customer. In an embodiment, ASR 102 may use the RFM attributes to segment customers.

Data collection or retrieval is usually the first step to begin the segmentation process. The data may include sales conversion and customer engagement or interaction data that includes information about interactions between a customer or prospective customer and representatives or products of a company, and resultant sales (or non-sales).

In an embodiment, this historical data may include both data collected online or through offline interactions. For example, segmentation data may include retail brick-and-mortar store or online website traffic, as well as customer profiles, customer surveys, purchase history, chat history, returns, customer inquiries, sales histories, income, credit scores, etc.

The sales or historical data may include customer demographic data, and may even differentiate between leads and referrals for prospects—that indicate how customers have contacted or come into contact with a company. In an embodiment, the segmentation may be based on how the customer came to find out about the particular product offering or company. For example, customers who reached out to the company or received an advertisement from the company on a first social media platform may be in one segment, while customers associated with a second, different social media platform may be in a different segment. Then, for example, people who responded to printed flyers may be in a different segment than the social media platform customers.

In an embodiment, the historical data may be retrieved or received into ASR 102 as leads and referrals 104. In an embodiment, leads and referrals 104 may include historical data of previous leads and/or referrals of prospective customers that were received, handled, and closed (e.g., either resulting in a sale or not).

Based at least in part on the collected or retrieved historical data 104, ASR 102 may divide the customers into groups or segments, in which each group or segment shares some similar, related, or overlapping data or data values. For example, customers with credit scores between 500-600 may be a segment, while customers in a particular zip code may be a second segment, and a third segment may include males over the age of 45. The same set of data may be segmented any different or infinite number of ways. In an embodiment, different segments may include overlapping data, such that a particular customer may fall into two different segments simultaneously.

In an embodiment, ASR 102 may apply lead scoring techniques to help sales and marketing departments identify which prospects are potentially most valuable to the company and its current sales funnel. In an example of lead scoring, point values may be assigned to different actions a lead or customer may take in the sales funnel, and/or to different attribute data about customers. For example, clicking a link may be two points, and watching a half a video may be three points, while watching an entire video may be four points. Other actions include reading a blog post, filling out a form, reading an email, calling a helpline, requesting a price quote, etc. The points may also be applied to various demographic or customer information, such as age, location, purchase history, credit score, income, etc.

The points may be used to determine which prospects are “hot”, or most likely ready to purchase a product or service. This may help salespeople better use their time and resources to focus on the warmer or hot prospects. This may lead to higher conversions, higher close rates, increased sales, and more satisfied customers.

By focusing on customers who have met a threshold point total, have a highest number of points, or who have taken a specific step or action, salespeople may improve their performance and better utilize their resources, including computing resources and bandwidth. However the effectiveness of the lead scoring may be limited by how accurately points are assigned to various activities that indicate a customer's readiness to purchase, or take another action. A company may need to determine what action(s) and/or demographic information shift a customer's focus from interest (e.g., wanting to learn more) to intent (e.g., ready to purchase).

When a consumer or prospect takes a specific action or who has satisfied certain attribute information (e.g., whose point total exceeds a threshold value), their information may be provided to sales team member through the lead scoring system or platform. This may be done in an automated process, which may be improved over time through machine learning and/or artificial intelligence.

Lead scoring, as performed by ASR 102, makes it easier for a company or salesperson to determine the top prospects, including when and/or how to reach out to the customer. The effectiveness of a lead scoring system may depend on how a ‘top prospect’ is defined, how customers are segmented and ranked, to what attributes or actions points are assigned, and what actions are to be performed with regard to the identified top prospects.

Artificial intelligence and/or machine learning may be used to determine or predict which behavioral patterns and/or consumer data may be used to predict when a consumer will make a purchase. Greater use of such systems, allowing for more test points and data, can improve the accuracy of such predictions over time.

In an embodiment, in performing lead scoring, ASR 102 may use rule-based and/or clustering techniques with machine learning that divides or groups the leads and referrals into different segments, and then scores and ranks the segmented customers. The ranked customers may then be provided to sales managers, which may enable sales managers to prioritize their workload based on the segment of prospects for which they are responsible. The managers may first focus their energies on the prioritized, highest ranked, and predicted to be the most likely to convert leads. The system can be improved over time through machine learning that receives and processes ongoing results or larger data sets.

Further, rather than simply outputting a single lead scoring pipeline for a company, ASR 102 may segment prospects by the various products or service offerings of a company, and score the prospects relative to the likelihood of conversion across one or more of the products and/or services. ASR 102 may also output a global list or ranking as well across all products or services. In an embodiment, ASR 102 may group certain products together and score relative prospects for the group.

Rather than requiring a salesperson to manually review the available data and rank prospects, which is an approach that only effective for a smaller number of leads and cannot be scaled easily, ASR 102 automatically segments, ranks, and provides different prioritized lists of leads for different product lines of a company. One drawback of manual review is that if a salesperson who is manually reviewing customer information leaves the company, the company will lose its ability to score the customer without the salesperson. Another problem is that the manual process could be further complicated as the company's product offerings grow, change, or become more varied, thus manual review will consume greater resources and produce increasingly more unreliable results.

Scoring leads and referrals is challenging, especially when the leads can belong to multiple buckets or categories. For example in retail banking, ranking leads and referrals for home loan and auto-loan together may not make sense. As such, the system described herein may segment or cluster the customers and prospects to obtain more accurate results.

ASR 102 may initially create, group, or generate customer segments based on salesperson recommendations/input, historical data, generates data models, and ranks customers based both on a per-segment and global basis. Then, for example, leads or referrals 104 that are scored and ranked higher (with a higher likelihood of conversion and/or at a higher dollar amount) may be contacted first or assigned the most resources (such as ad targeting), which may ultimately have a larger impact on the business in the growth of sales. In an embodiment, limiting ads or marketing material to being sent to specific customer segments that are likely to convert, and not others, saves on computing resources and bandwidth, while maximizing sales, revenue, and customer satisfaction.

As noted above, ASR 102 may use a combination of both rule based segmentation and machine learning that can automatically group the leads into segments and then rank and score the leads for each segment (and globally across multiple segments or all segments as well). This may enable sales managers to prioritize their workload based on the segment to which they are attached and focus on the prioritized leads. For example, in a banking embodiment in which three product lines are offered: home loans, auto loans, and credit cards, the system may output ranked lists of prospects for each of the product lines individually, for the loans (home and auto), and across all three product lines globally.

In an embodiment, for new product lines or product lines for which there is a limited amount of historical data available, the sales persons may use either the global or a combination prioritization list. In an embodiment, ASR 102 may provide or output top referrals and leads based on learned, segmented models.

In an embodiment, ASR 102 may identify the parameters which may be used to create the segments in leads using either a rule based or clustering and machine learning based approach. ASR 102 may for example, analyze the available data using various data processing techniques and/or receive user input to determine how to segment the clients.

In an embodiment, after the segmentation criteria is decided, machine learning based models may be created and/or used by ASR 102 to rank the various customers based on a probability of converting the prospects into paying customers or clients. In an embodiment, ASR 102 may use the same ranking techniques to rank the leads or referrals, regardless of whether they are segmented or clustered.

In an embodiment, the segmentation logic 108 may include rules-based segmentation (RBS) or clustering-based segmentation (CBS). RBS may allow salespersons to determine how to segment leads and referrals.

In an embodiment, the RBS segments may correspond to various product lines or service offerings. For example, a bank may offer home loans (segment 106A), auto loans (segment 106B), and credit cards (segment 106C). Or, for example, segmentation may be performed based on particular attributes of prospects or customers that a salesperson has identified as being important with regards to how to divide up customers, such as zip code, age, or income.

In an embodiment, salespeople may be able to use their industry experience to develop an initial set of segmentation, scoring, and/or ranking criteria as received by ASR 102, as rules-based segmentation logic 108. ASR 102 may then use the salespersons experiences to determine which activities and/or attributes are the most valuable, or likely to lead to conversions or sales. Then through machine learning, artificial intelligence, and/or clustering of larger data sets, the initial salesperson rules may be improved over time and sustained even when the salesperson leaves the company.

During an initialization phase, ASR 102 may segment the initial leads and referrals 104 into different segments 106A, 106B, 106C, based on a segmentation logic 108 (which may be rules-based and/or machine learning compatible).

Leads may be or indicate an interest or entry of a customer or potential customer into a company's sales funnel. The leads may be received by happenstance, through user interactions with a website, social media, or an online form, by clicking a link, etc. Or, for example, a lead may be a customer walking into a store.

Referrals may be introductions to the company, or the products of the company, from previous or current customers, employees, or associates of the particular company. Both leads and referrals may be referred to as prospects, customers, potential customers or purchasers of a company's products or services. In an embodiment, leads and referrals may include existing customers who are seeking to expand their relationship with the company by purchasing or signing up for additional products or services.

A salesperson of a company may only have a limited amount of time through which to contact potential customers. As such, the salesperson needs a system by which to rank the prospects or potential customers (e.g., leads and referrals), so that the salesperson is prioritizing the most likely converting potential customers (the customers who are most likely to purchase) above those who are less likely to convert. In an embodiment, historical data of a company may reveal that referrals covert at a higher rate than leads. As such, referrals may be ranked above leads, and segmented separately.

However, beyond the high level differentiation between leads and referrals, additional attributes about customers or potential customers may also signal or indicate a potential likelihood of conversion. For example, customers in a particular zip code or of a particular age range may convert at a higher percentage than other customers.

Furthermore, the projected or predicted conversion rate and the attributes that may be determined or predicted to signal a greater likelihood of conversion may vary based on the type of product or service being offered by a company. For example, people between the ages of 35-45 may have a higher conversation rate than people older than 45 for Product A, while the opposite may be true for Product B, and product C may appeal to people over 65 more than people under 65. In other embodiments, different customer segments or attributes (including but not limited to age) may also be used such as gender, marital status, income, and credit score.

In an embodiment, ASR 102 may assign scores to different customer leads and referrals 104, based on various attributes and historical data including tracked actions, to determine the likelihood of the customer being a converting customer. This information may then be used by salespersons to determine on which customers to focus their time, energy, money, and other resources.

As described herein, ASR 102 may use either an automated rules-based approach or clustering-based approach to segmentation rather than relying on an inconsistent and time consuming manual process. ASR 102 then use a machine learning model for ranking the segmented leads and referrals, and may even differentiate between (e.g., segment and/or rank differently) leads and referrals. The lead ranking system of ASR 102 may also differentiate between various product lines or company offerings, using different attributes to segment leads and/or referrals. In an embodiment, for a particular product line a first set of attributes A, B, and C may be used for leads, while a second set of attributes B, D, F, and G may be used for referrals.

In another embodiment, segmentation logic may include clustering functionality (e.g., in CBS), in which one or more computing devices of ASR 102 use various clustering techniques to determine how to group, segment, or cluster the leads and referrals. Example clustering techniques include, but are not limited to, K-means clustering and Gaussian mixture model (GMM) clustering.

Training filters 110 may use historical or past data (e.g., which may include lead and referral data 104) to determine which attributes (or combinations of attributes) of the data are likely to yield to conversions, sales, or other desired results. A conversion may be when a customer or prospective customer decides to purchase a product or service. ASR 102 may use the training filters 110 to analyze, evaluate, or process past or historical data with known results (e.g., whether the prospect resulted in a sale or not), to identify which attributes or various combinations of attributes correspond to the sales.

For example, training filters 110 may determine or generate a model (or portion thereof) that indicates that the best prospects (e.g., with the highest projected likelihood of conversion) include the combination of income being greater than $100,000 and zip code being one of a set of five identified zip codes. These attributes (income and zip code) may be used to segment or rank prospects from new or incoming leads and referrals 104.

In an embodiment, training filters 110 may include validation functionality. In an embodiment, validation may also be performed using a portion historical data (with known results) that was not used for training or model generation as described herein. For example, a company may include past prospect data (e.g., leads and/or referrals) and sales conversions and failures over the previous year. A portion of the historical data (e.g., 70% or 80%) may be used for training purposes, and a smaller or remaining portion may be used for validation. For example, a user or ASR 102 may identify the first 11 months of leads and referral data 102 for training, and the most recent 1 month for validation.

In an embodiment, training filters 110 may produce a variety of intermediate models for each segment. For example, prior to identifying the income levels and zip codes that correspond to the highest conversion rate for segment A (as referenced in the example above), ASR 102 may test various other combinations of attributes, such as age, education, gender, and marital status. Each of these sub-models may then be tested against the validation data. In an embodiment, ASR 102 may activate a model when a model satisfies a validation threshold for accuracy or predictability.

In an embodiment, these various intermediate or sub-models may be generated by a classifier or classification engine of training filters 110 that uses any various combinations of classification techniques to generate the intermediate models. Example classification techniques which may be used include, but are not limited to, decision trees, random forests, gradient-based trees, linear trees, logistic regression with elastic net regularization and Naïve Bayes.

The resulting intermediate models may be tested against validation data may produce an accuracy measure. The accuracy measure may be an indicator of how closely the intermediate models were able to predict the actual outcome or result (e.g., conversion or not). The same validation data may be used to test each intermediate or sub model.

Training filters 110 may then select the sub or intermediate model with the highest accuracy measure for each segment as determined from the validation data, and output a final, usable model 112A (for segment A). Training filters 110 may also perform similar processes for segments 106B and 106C, and produce models 112B and 112C. In an embodiment, if the accuracy of a particular model does not satisfy a threshold, then no model may be output for that particular segment, and the global model 112D may be used instead until the model is improved and/or more data is received.

In an embodiment global model 112D may be a predicted conversion model for the set of prospects (e.g., lead and referrals) generally or across all or a subset of segments, and is not specific to any one particular product or service offering, or identified segment. In an embodiment, global model 112D may be used by salespersons to prioritize leads when a particular segment, such as a new product offering for a new segment D, is initiated but there is not yet enough data to validate its own model for that particular segment or when a segment model could not be generated to satisfy the accuracy threshold.

Once the models 112A-D are generated, they may be ready to receive, process, and rank live data 104. The generated models may receive live data and output a ranked set of leads 114A-D based on input data. In an embodiment, a particular prospect (e.g., lead and/or referral) may be processed by two or more of the models, and the outputs may either be mutually exclusive or include overlapping prospects. For example, lead b may rank differently across models 112A-C and may not be ranked or included in the global model 112D, or may have scored below a threshold for the global model 112D so it does not appear on the ranking list 114D provided to the salespersons.

The model outputs (e.g., ranked leads 114A-D) may then be forwarded or otherwise provided to the salespersons who are responsible for those particular segments of customers or prospective customers. The salespersons may then, based on the output, determine how best to use their limited time, money, computing, and other resources to focus on those customers or prospects who are most likely to convert (e.g., purchase). This will likely improve the sales numbers, the company's profitability, and satisfy the customer's needs. The rankings 114A-D may be time sensitive, and may vary over time (e.g., as recency measures change with time).

In an embodiment, the results from a salesperson using the output or ranking, may then be provided back into ASR 102 as new training and/or validation data, and may be used to improve the segmentation, clustering, and/or ranking processes using machine learning and/or artificial intelligence techniques, refine the models 112A-D, and update the rankings 114A-D.

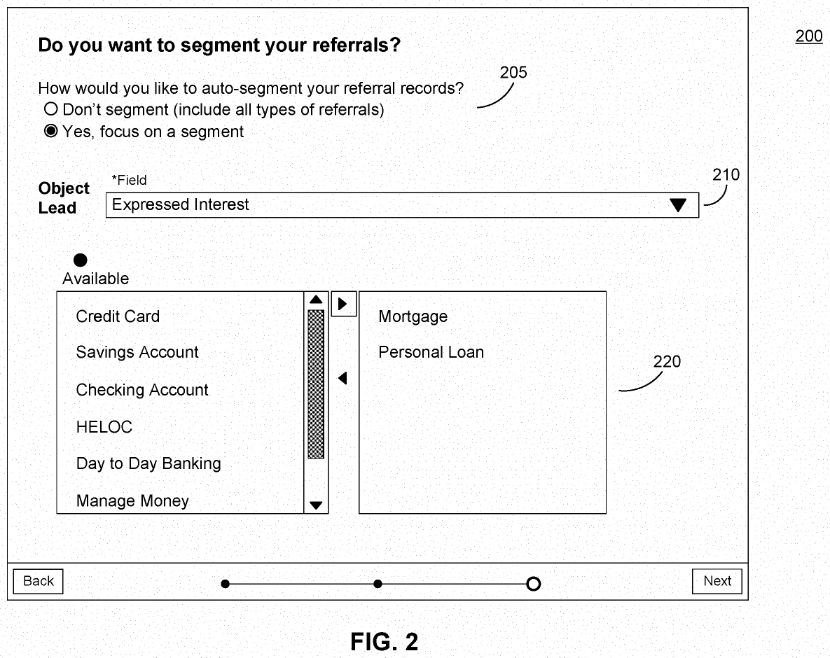

FIG. 2 is an example interface 200 of the system described herein, according to an embodiment. In section 205, ASR 102 may enable sales persons to identify how they want to segment prospect data that may include lead and referral data. ASR 102 may alternatively allow the salesperson to select automated system clustering. For example, if a salesperson wants ASR 102 to use a global model 112D or is selling a new product line, the salesperson may select the “don't segment” option that may cause ASR 102 use the clustering process described herein without salesperson input on how to initially segment the customers.

If the user or salesperson selects yes, then ASR 102 may provide the user various options as to how to segment the data. Two example options are illustrated in interface 200. For example, in section 210, the user may select what types of interactions associated with leads or referrals the user wants to use. The selected option is “expressed interest”, however other example options include referral, indirect interest, or customer of different product.

In section 220, the user may be able to select particular attributes by which the user or salesperson wants to further segment the customers. In a clustering embodiment, the salesperson may be able to identify how many clusters the salesperson prefers. This may be an optional selection.

In an embodiment, ASR 102 may include or use a predictive model for scoring leads, referrals, and/or other prospects. Thus, ASR 102 allows a sales team to prioritize their referral pipeline based on historical successful conversion patterns.

As referenced above, in an embodiment, ASR 102 may use rules-based segmentation. An administrator or other user may provide or define the rules that are used to create the segments. For example, if the lead or referral has expressed interest in a specific type of loan, an example set of rules by which to segment the leads may be defined as follows:

1) If the Expressed Interest is Home Loan→Segment A

2) If Expressed Interest is Auto Loan→Segment B

3) If expressed interest is both→Segment C.

Another set of example rules may segment the leads based on a particular feature or attribute. For example, the rules may state that:

1) If age of a lead/customer is less than 40 than home loan→Segment A

2) If the age of a lead/customer is less than 30 then automobile loan→Segment

B.

ASR 102 segmentation may generate predictions for each filed value on the lead object. For example, the selections on interface 200 may cause ASR 102 to generate a prediction based only on referrals who have expressed an interest on investments, whereby each picklist value of the dataset (e.g., mortgage and personal loan) gets its own prediction. In an embodiment, the predictions may be provided as scores and provided as rankings 114A-D.

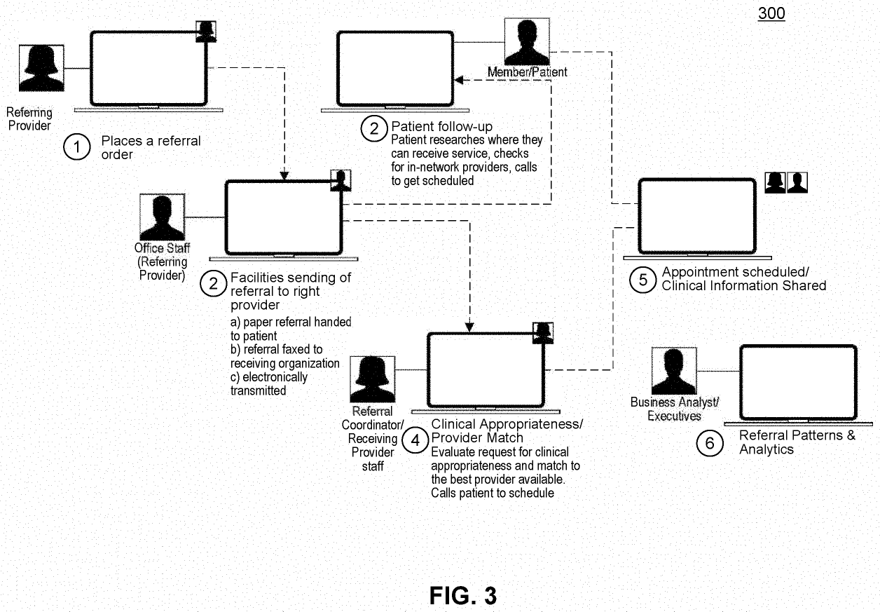

FIG. 3 illustrates an example flowchart 300 for providing a system for the automatic segmentation and ranking of leads and referrals in an example healthcare embodiment. The order of the steps provided in flowchart 300 are exemplary, and other embodiments, may include a varied ordering of steps. The use of ASR 102 in healthcare is also exemplary, and may be applied to other industries as well.

In step 1, a doctor may refer a patient to another doctor's office. In step 2, the office staff or system may refer the patient to the proper doctor (if multiple doctors from whom to select). In steps 3 and 4, the patient and doctor may be matched and an appointment scheduled as illustrated in step 5. The results of this appointment, and/or the results of the previous steps (even if not resulting in an appointment), may be provided as training and/or validation data into ASR 102 as described herein.

Then, for example, when a referral is received, it may be segmented or clustered based on models, and analyzed and ranked to determine what resources should be deployed towards trying to schedule an appointment with the patient. For example, whether to give the patient a sooner appointment (for higher converting referrals) or a later appointment (for lower converting referrals).

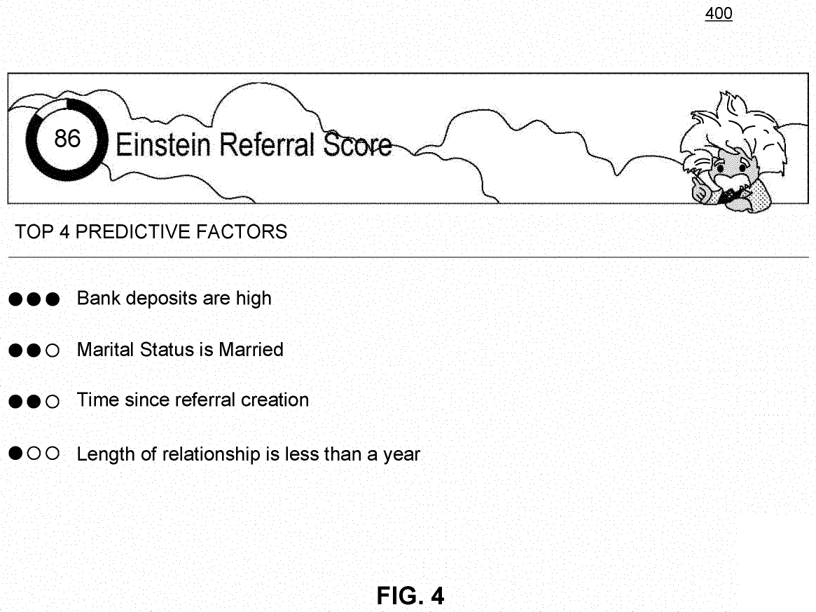

FIG. 4 is a screenshot 400 of an example referral scoring output, according to an embodiment. In an embodiment, ASR 102 may generate a predictive model (or models) for scoring referrals (and leads) across various product and/or customer segments. The ASR 102 predictions or scoring may enable sales teams determine how to prioritize how to deploy their resources, based on the predictions as to which prospects are most likely to convert. For example, to which customers to transmit marketing materials or appointment requests, phone calls, emails, etc.

In an embodiment, the various models that are generated may be based on different information such as who is referring the individual, demographic data, account data, conversion history of a particular branch or salesperson (including experience or tenure). In an embodiment, ASR 102 may output scores and/or rankings of particular user profiles across one or more segments or product lines. In an embodiment, the rankings may be for particular offices or salespersons, which enable them to prioritize their referral pipeline based on historical successful conversion patterns.

In an embodiment, the model drivers may include a referral profile and financial account details such as money balance, segment, account age, etc. ASR 102 may also track referrer conversion history information such as branch, tenure, or salesperson and experience of the salesperson handling the conversion. ASR 102 may also request or track and log the output or result of the sales. This result information may then be used to further refine, train, or validate the predictive models.

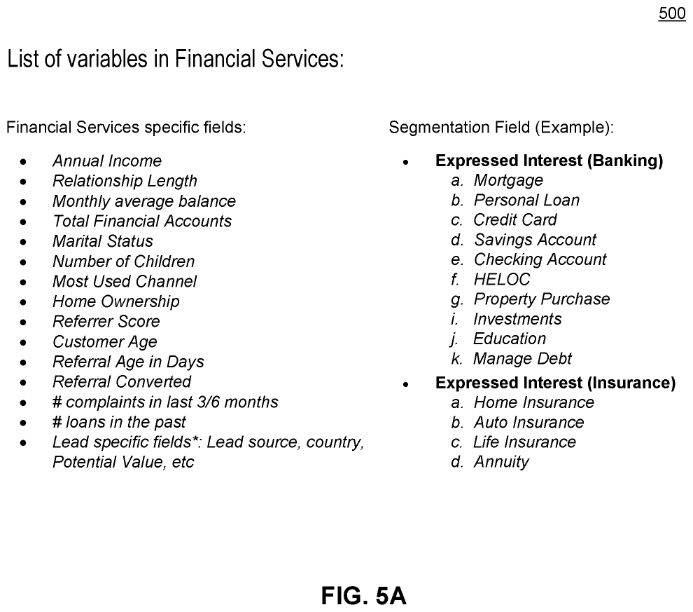

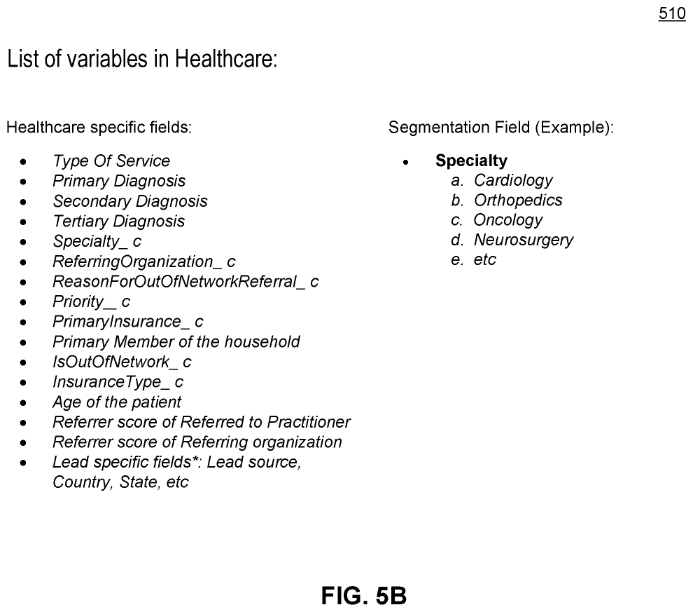

FIGS. 5A and 5B describes various variables and attributes that may be assigned scores for ranking leads and referrals, according to some example embodiments. This list 500 in FIG. 5A illustrates example variables in a financial services embodiment, while the list 510 in FIG. 5B illustrates example variables in a healthcare embodiment. The expressed interest may indicate a specific product or service line in which the prospect has already expressed an interest or made a purchase.

For example, a customer may have requested a price quote on a particular convertible automobile. This may help a salesperson determine that the user is interested in convertibles or small cars, and not sport utility vehicles or vans, in a car dealership example.

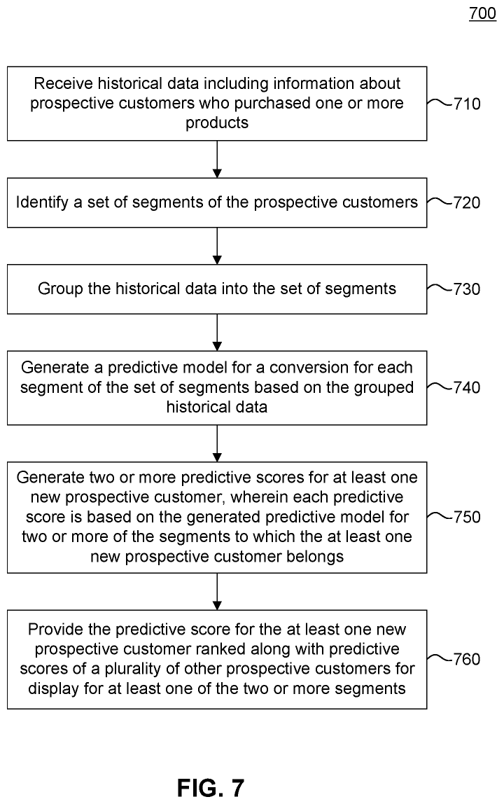

FIG. 7 is a flowchart 700 illustrating example operations for providing a system for the automatic segmentation and ranking of leads and referrals, according to some embodiments. Method 700 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 7, as will be understood by a person of ordinary skill in the art. Method 700 shall be described primarily with reference to FIG. 1.

In 710, historical data including information about prospective customers who purchased one or more products is received. For example, ASR 102 may receive historical lead and referral data 104. The historical data 104 may include data such as interactions history and sales or purchase (and refund) history between a current, former, or prospective customer and one or more associates of a company or organization. The data 104 may include the results of interactions, e.g., whether a customer set up an appointment, purchased a product or service, etc.

In 720, a set of segments of the prospective customers may be identified. For example, a salesperson may use their experience and submit a set of rules as segmentation logic 108 which may be used to initially segment the historical data 104.

In 730, the historical data may be grouped into the set of segments. For example, ASR 102 may use the salesperson provided rules to segment the historical data set. n another embodiment, ASR 102 may use clustering technology or algorithms to divide the initial, training, or historical set of customers into segments 106A-C. In an embodiment, the segments 106A-C may be based on product lines or services, interactions data, and/or customer demographic data. Over time, the segments 106A-C may change or be adjusted both in number and makeup.

In 740, a predictive model for a conversion is generated for each segment of the set of segments based on the grouped historical data. For example, training filters 110 may perform analysis on the various segments 106A-C to determine what factors or attributes of customers lead to sales, conversions, or other desired outputs or results. This scoring analysis may be saved as the models 112A-C. In an embodiment, ASR 102 may also generate a global model 112D across all the customers, segments 106A-C, and/or product lines.

In an embodiment, a portion of the historical data may be used as validation data, and used to validate the accuracy of models 112A-D. ASR 102 may refine any of the models 112A-D until their accuracy reaches a particular threshold, which may vary by salesperson, product line, or industry.

In 750, two or more predictive scores are generated for at least one new prospective customer, wherein each predictive score is based on the generated predictive model for two or more of the segments to which the at least one new prospective customer belongs. For example, based on a salesperson's preferences, ASR 102 may then score the incoming leads and/or referrals 104 based on two or more of the corresponding models 112A-D. In an embodiment, not every model 112A-D may be used to score every incoming lead or referral 104. In an embodiment, ASR 102 may score a prospect against two of the models 112A and 112D, and output the scores together on the same display so they are simultaneously viewable.

In 760, the predictive score f for the at least one new prospective customer is ranked along with predictive scores of a plurality of other prospective customers and provided for display for at least one of the two or more segments. For example, ASR 102 may generate various rankings 114A-D. The rankings 114A-D may rank the various leads 104 in accordance with how the particular lead was segmented and against which of the models 112A-C the lead was scored. As illustrated, the same lead may have a different rank in different rankings 114A-D. The rankings 114A-D may be output on a display screen for a salesperson.

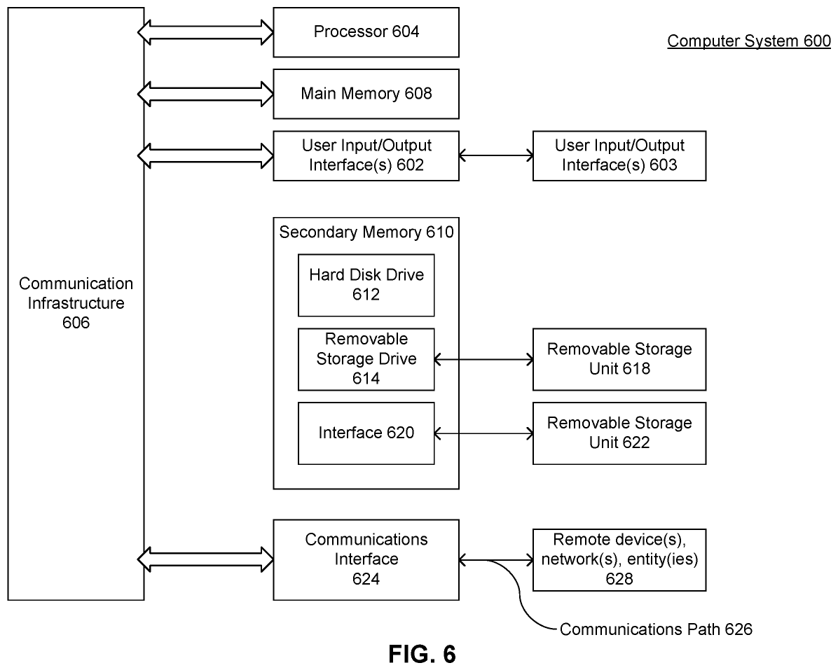

Various embodiments can be implemented, for example, using one or more computer systems, such as computer system 600 shown in FIG. 6. Computer system 600 can be used, for example, to implement the systems described above with respect to the figures, and/or the method of FIG. 6. Computer system 600 can be any computer capable of performing the functions described herein.

Computer system 600 can be any well-known computer capable of performing the functions described herein.

Computer system 600 includes one or more processors (also called central processing units, or CPUs), such as a processor 604. Processor 604 is connected to a communication infrastructure or bus 606.

One or more processors 604 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 also includes user input/output device(s) 603, such as monitors, keyboards, pointing devices, etc., that communicate with communication infrastructure 606 through user input/output interface(s) 602.

Computer system 600 also includes a main or primary memory 608, such as random access memory (RAM). Main memory 608 may include one or more levels of cache. Main memory 608 has stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618.

Removable storage unit 618 includes a computer usable or readable storage device having stored thereon computer software (control logic) and/or data. Removable storage unit 618 may be a floppy disk, magnetic tape, compact disk, DVD, optical storage disk, and/14884828-1 any other computer data storage device. Removable storage drive 614 reads from and/or writes to removable storage unit 618 in a well-known manner

According to an exemplary embodiment, secondary memory 610 may include other means, instrumentalities or other approaches for allowing computer programs and/or other instructions and/or data to be accessed by computer system 600. Such means, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 enables computer system 600 to communicate and interact with any combination of remote devices, remote networks, remote entities, etc. (individually and collectively referenced by reference number 628). For example, communication interface 624 may allow computer system 600 to communicate with remote devices 628 over communications path 626, which may be wired and/or wireless, and which may include any combination of LANs, WANs, the Internet, etc. Control logic and/or data may be transmitted to and from computer system 600 via communication path 626.

In an embodiment, a tangible apparatus or article of manufacture comprising a tangible computer useable or readable medium having control logic (software) stored thereon is also referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method, comprising:
receiving historical data including information about prospective customers who purchased one or more products;
identifying a set of segments of the prospective customers;
grouping the historical data into the set of segments;
generating a predictive model for a conversion for each segment of the set of segments based on the grouped historical data;
generating, by a processor, two or more predictive scores for at least one new prospective customer, wherein each predictive score is based on the generated predictive model for two or more of the segments to which the at least one new prospective customer belongs; and
providing the predictive score for the at least one new prospective customer ranked along with predictive scores of a plurality of other prospective customers for display for at least one of the two or more segments.

2. The method of claim 1, further comprising:
identifying a first portion of the history data to use as training data and a second portion of the historical data to use as validation data, wherein the grouping comprises grouping the training data into the set of segments.

3. The method of claim 2, wherein the generating the predictive model further comprises:
submitting the validation data to predictive model to generate a set of intermediate results; and
comparing the intermediate results to actual results from the validation model, wherein the actual results indicate whether a sale was converted.

4. The method of claim 3, further comprising:
determining, based on the comparison, that the predictive model exceeds a threshold; and
activating the predictive model to receive data for the at least one new prospective customer based on the threshold being exceeded.

5. The method of claim 1, wherein each segment corresponds to one of the one or more products.

6. The method of claim 5, wherein the set of segments include a global segment that includes data across all of the one or more products.

7. The method of claim 6, wherein the providing comprises:
determining that the at least one new prospective customer falls into two of the segments, and wherein the at least one new prospective customer is ranked differently for each of the two segments.

8. A system comprising:
a memory; and
at least one processor coupled to the memory and configured to perform operations comprising:
receiving historical data including information about prospective customers who purchased one or more products;
identifying a set of segments of the prospective customers;
grouping the historical data into the set of segments;
generating a predictive model for a conversion for each segment of the set of segments based on the grouped historical data;
generating, by a processor, two or more predictive scores for at least one new prospective customer, wherein each predictive score is based on the generated predictive model for two or more of the segments to which the at least one new prospective customer belongs; and
providing the predictive score for the at least one new prospective customer ranked along with predictive scores of a plurality of other prospective customers for display for at least one of the two or more segments.

9. The system of claim 8, the operations further comprising:
identifying a first portion of the history data to use as training data and a second portion of the historical data to use as validation data, wherein the grouping comprises grouping the training data into the set of segments.

10. The system of claim 9, wherein the generating the predictive model further comprises:
submitting the validation data to predictive model to generate a set of intermediate results; and
comparing the intermediate results to actual results from the validation model, wherein the actual results indicate whether a sale was converted.

11. The system of claim 10, the operations further comprising:
determining, based on the comparison, that the predictive model exceeds a threshold; and
activating the predictive model to receive data for the at least one new prospective customer based on the threshold being exceeded.

12. The system of claim 8, wherein each segment corresponds to one of the one or more products.

13. The system of claim 12, wherein the set of segments include a global segment that includes data across all of the one or more products.

14. The system of claim 13, wherein the providing comprises:
determining that the at least one new prospective customer falls into two of the segments, and wherein the at least one new prospective customer is ranked differently for each of the two segments.

15. A non-transitory computer-readable storage medium having instructions stored thereon that, when executed by at least one computing device, cause the at least one computing device to perform operations comprising:
receiving historical data including information about prospective customers who purchased one or more products;
identifying a set of segments of the prospective customers;
grouping the historical data into the set of segments;
generating a predictive model for a conversion for each segment of the set of segments based on the grouped historical data;
generating, by a processor, two or more predictive scores for at least one new prospective customer, wherein each predictive score is based on the generated predictive model for two or more of the segments to which the at least one new prospective customer belongs; and
providing the predictive score for the at least one new prospective customer ranked along with predictive scores of a plurality of other prospective customers for display for at least one of the two or more segments.

16. The non-transitory computer-readable storage medium of claim 15, the operations further comprising:
identifying a first portion of the history data to use as training data and a second portion of the historical data to use as validation data, wherein the grouping comprises grouping the training data into the set of segments.

17. The non-transitory computer-readable storage medium of claim 16, wherein the generating the predictive model further comprises:
submitting the validation data to predictive model to generate a set of intermediate results; and
comparing the intermediate results to actual results from the validation model, wherein the actual results indicate whether a sale was converted.

18. The non-transitory computer-readable storage medium of claim 17, the operations further comprising:
determining, based on the comparison, that the predictive model exceeds a threshold; and
activating the predictive model to receive data for the at least one new prospective customer based on the threshold being exceeded.

19. The non-transitory computer-readable storage medium of claim 15, wherein each segment corresponds to one of the one or more products.

20. The non-transitory computer-readable storage medium of claim 19, wherein the set of segments include a global segment that includes data across all of the one or more products.
